(19) United States
(12) Patent Application Publication
(10) Pub. No.: US 2006/0258215 A1
(43) Pub. Date: Nov. 16, 2006

(54) USB aromatic dispenser

(76) Inventors: Chang-Chin Lai, Taipei (TW); Yung-Chien Cheng, Taipei (TW)

Correspondence Address: HARNESS, DICKEY & PIERCE, P.L.C., P.O. BOX 8910, RESTON, VA, 20195, US

(21) Appl. No.: 11/127,084

(22) Filed: May 12, 2005

(51) Int. Cl. H01R 13/648

(52) U.S. Cl. 439/607

(57) ABSTRACT

A USB dispenser having a USB connector is applied to a USB-interface electronic device. The USB aromatic dispenser includes a casing, a USB connector and a heating element. When the USB connector connects to the USB interface to obtain power, the aromatic inside the casing is heated by the heating element and thereby distributes vapors outside of the USB aromatic dispenser.

### BACKGROUND OF THE IVENTION

1. Field of the Invention

The invention relates to an aromatic dispenser, and particularly to a USB aromatic dispenser using a USB (universal series bus) interface.

2. Brief Description of Related Art

Aromatic therapy has being been widely applied since aromatic plants were first discovered. An aromatic atmosphere can relieve fatigue and pressure accumulated day-by-day, especially in our modern and busy industrial and commercial society, and so it has become increasingly welcome.

The aromatic dispenser has been developed for aromatic distribution. The aromatic dispenser typically contains aromatics inside a container and distributes aromatic vapors. Recently, an electric aromatic dispenser has been proposed. The electric aromatic dispenser has an electric plug complying with domestic electricity outlets for power supply. Such an aromatic dispenser is applied in the interior of homes or automobiles. However, there is no aromatic dispenser applied in electronic devices that are in close contact with daily life.

### SUMMARY OF THE INVENTION

An object of the invention is therefore to provide a USB aromatic dispenser having a USB connector for connecting to a USB-interface electronic device. Via the USB connector, the USB aromatic dispenser dispenses aromatic vapors that are generated by the power supply of the external electronic device.

In order to achieve the above and other objectives, the USB aromatic dispenser of the invention can be mounted on an USB-interface electronic device. The aromatic dispenser includes a casing, an USB connector and a heating element. The USB connector and the heating element are accommodated inside the casing. The USB connector connects to the USB interface and transmits electrical power from the electronic device via the USB interface. The heating element receives the electronic power from the USB connector and transforms it into heat energy for heating the aromatic dispenser.

### BRIEF DESCRIPTION OF THE DRAWINGS

FIG. 1 is a schematic view of a USB aromatic dispenser according to the first embodiment of the invention.

FIG. 2 is a cross-sectional view of a USB aromatic dispenser according to the first embodiment of the invention.

FIG. 3 is a cross-sectional view of a USB aromatic dispenser according to the second embodiment of the invention.

FIG. 4 is a schematic view of a USB aromatic dispenser according to the third embodiment of the invention.

FIG. 5A˜5C are top views of a USB aromatic dispenser according to the third embodiment of the invention.

### DETAILED DESCRIPTION OF THE PREFERRED EMBODIMENTS

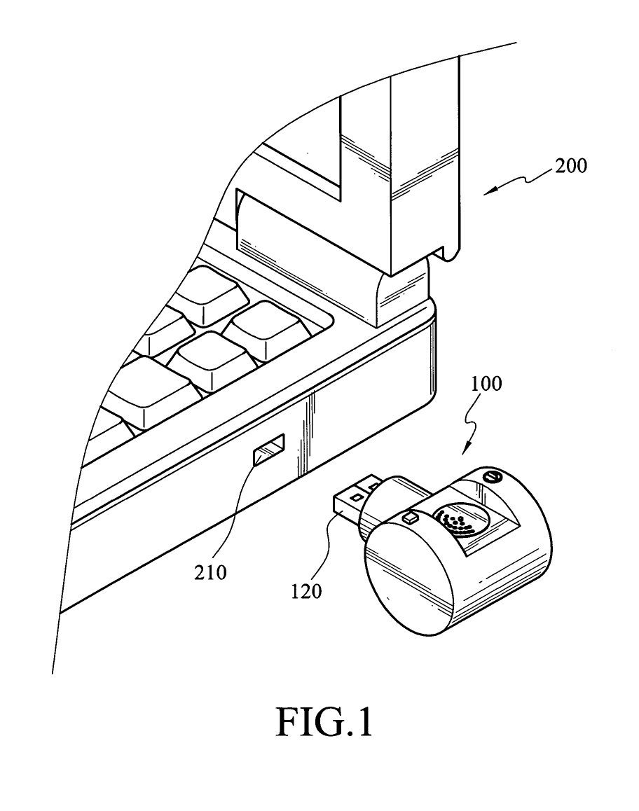

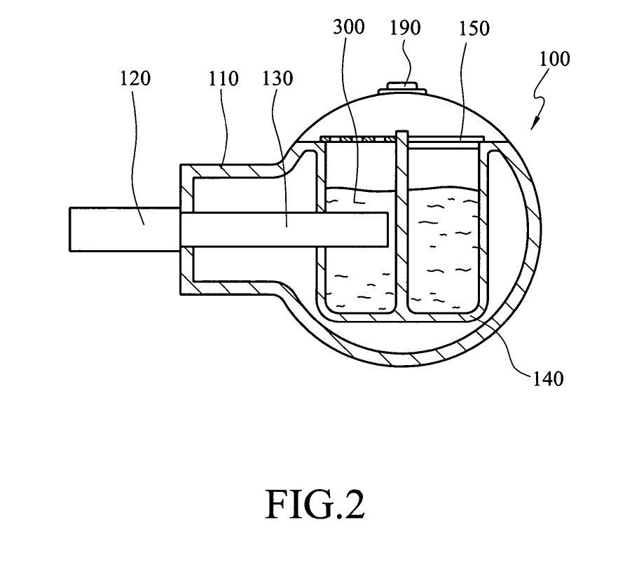

Referring to FIGS. 1 and 2, a USB dispenser 100 in one embodiment of the invention is applied to an electronic device with a USB interface 210, such as laptop computer 200 so that aromatic 300 is evaporated by means of the electrical power of the electronic device. The USB aromatic dispenser 100 includes a casing 110, a USB connector 120 and a heating element 130.

The casing 110 is a hollow casing with an accommodating space 140 therein for containing the aromatic 300. A lip 150 lies above the accommodating space 140. The lid 150 is detached to charge the aromatic 300 into the accommodating space 140. The lid 150 can be of network shape that allows the aromatic vapors to be distributed externally. The USB connector 120 essentially includes a power/data circuit that provides power and data transmission. A first end of the power/data circuit is mounted inside the casing 110. A second end of the power/data circuit extends from the casing 110 to connect to the USB interface 210 to obtain power and data from laptop computer 200. The heating element 130 is mounted at the bottom of the accommodating space 140 and connects to the USB connector 120 to convert the power from the laptop computer 200 into heat energy for evaporating the aromatic 300.

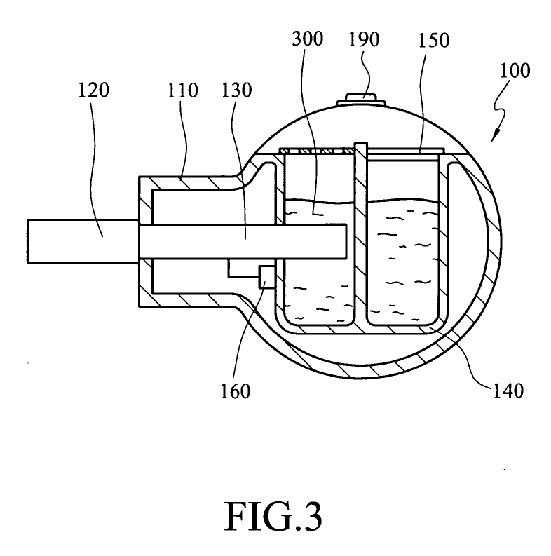

Furthermore, as shown in FIG. 3, the casing 110 of the aromatic dispenser in this embodiment includes a temperature sensor 160, and connects to the USB connector 120 so that the laptop computer 200 is informed of the temperature detected by the temperature sensor 160. With such a design, the heating of the USB aromatic dispenser 100 can be monitored by the laptop computer 200. For example, when the temperature of the USB aromatic dispenser 100 is too high, the temperature is lowered by cutting off the power supply from the laptop computer 200 in order to prevent any toxic substances from being generated by overheating the aromatic 300. Meanwhile, any danger to the use can be prevented as well.

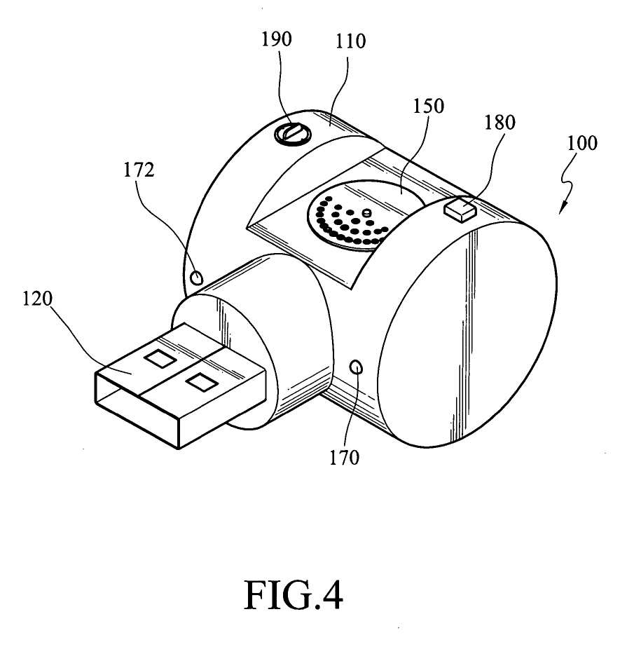

Referring to FIG. 4, in this embodiment, the casing 110 of the USB aromatic dispenser 100 has a plurality of indicating lights on its external surface. The usage condition can be determined by flashing or colors of the indicating lights. Power indicators 170 show whether the power supply is ON to determine the operating condition of the USB aromatic dispenser 100. Temperature indicators 172 show whether the temperature is too high and provide warning when it is.

Furthermore, for convenient use, a power switch 180 and a temperature control button 190 are mounted on the external surface of the casing 110 of the USB aromatic dispenser 100. The power switch 180 controls ON/OFF of the power supply. The temperature of the USB aromatic dispenser 100 can be adjusted by rotating the temperature control button 190. The temperature at which the aromatic is heated determines the distribution of the aromatic vapor. The position of the temperature control button 190 can be varied as desired.

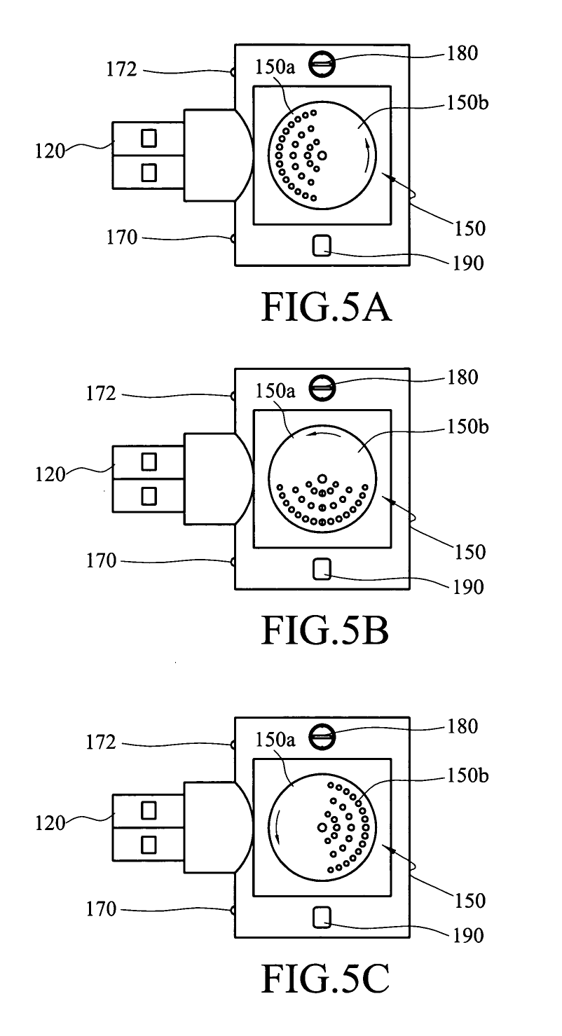

Referring to FIG. 5A˜5C, in the USB aromatic dispenser 100 part of the lid 150 hollowed-out. When in use, the lid 150 is rotated to align the hollowed-out part 150a with an open end of the underlying accommodating space 140 so that the fragrance of the aromatic 300 flows out of the dispenser 100 via the hollowed-out part 150a. That is, the proportion of the hollowed-out part 150a (also called the “communicating part”) above the accommodating space 140 relative to the area of the dispenser determines the fragrance concentration distributed externally. A non hollowed-out part (non-communicating part”) 150b of the lid 150 is rotated to align with the site of the aromatic 300 to close the open end of the accommodating space 140 so that any leakage of the aromatic 300 can be avoided.

As described above, the USB connector of the USB aromatic dispenser according to the invention connects to the USB interface of the electronic device. The data and power supply from the electronic device can be transmitted via the USB connector. The aromatic is heated by the power supply from the electronic device.

Furthermore, the temperature sensor is further used in the USB aromatic dispenser to connect to the USB connector to transmit temperature signals to the electronic device. The temperature indicators, the power indicators, the power switch and the temperature control button assist in control of the USB aromatic dispenser. The hollowed-out part of the lid is used to control the fragrance outside the USB aromatic dispenser.

It will be apparent to the person skilled in the art that the invention as described above may be varied in many ways. Such variations are not to be regarded as a departure from the spirit and scope of the invention, and all such modifications as would be obvious to one skilled in the art are intended to be included within the scope of the following claims.

What is claimed is:

1. An USB aromatic dispenser, mounted on an USB interface of an electronic device, used to distribute an aromatic fragrance, the USB aromatic dispenser comprising:
an USB connector, connecting the USB interface to get power supply from the electronic device;
a heating element, connecting to the USB connector to convert the power supply into heat energy for evaporating the aromatic; and
a casing, accommodating the aromatic, the USB connector and the heating element.

2. The USB aromatic dispenser of claim 1, further comprising a temperature sensor to measure the temperature of the aromatic dispenser.

3. The USB aromatic dispenser of claim 2, wherein the temperature sensor transmits a temperature signal to the electronic device via the USB connector.

4. The USB aromatic dispenser of claim 1, further comprising a temperature indicator to display the temperature of the aromatic dispenser.

5. The USB aromatic dispenser of claim 1, further comprising a temperature control button to control the heating element.

6. The USB aromatic dispenser of claim 1, further comprising a power indicator to display the use of power supply of the USB connector.

7. The USB aromatic dispenser of claim 1, further comprising a power switch to control connection and disconnection between the USB interface and the USB connector.

8. The USB aromatic dispenser of claim 1, further comprising a lid covering the casing, having a communicating part via which the aromatic fragrance is distributed.

9. The USB aromatic dispenser of claim 8, wherein proportion of the communicating part relative to the area of the USB aromatic dispenser determines the fragrance concentration distributed outside.

10. The USB aromatic dispenser of claim 1, further comprising an accommodating space mounting inside the casing for containing the aromatic.
